(19) United States
(12) Patent Application Publication
(10) Pub. No.: US 2008/0246941 A1
(43) Pub. Date: Oct. 9, 2008

(54) Wavefront aberration measuring device, projection exposure apparatus, method for manufacturing projection optical system, and method for manufacturing device

(76) Inventor: Katsura Otaki, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/783,235

(22) Filed: Apr. 6, 2007

(51) Int. Cl. G03B 27/54; G01B 11/00

(52) U.S. Cl. 355/67; 356/499

(57) ABSTRACT

A wavefront aberration measuring device includes a mask which arranges a group of minute apertures for generating a group of point light sources at an object point as a measurement objective of an inspection-objective optical system, an illumination system which illuminates the mask with an illumination light, a diffraction grating which shears, into a plurality of light fluxes, a light flux exiting from the group of minute apertures and passing via the inspection-objective optical system, and a detecting portion which detects an interference fringe formed mutually by the plurality of sheared light fluxes, wherein a center spacing distance L between adjacent minute apertures which are adjacent in a shear direction in the group of minute apertures is defined to minimize the coherence degree.

### BACKGROUND OF THE INVENTION

1. Field of the Invention

The present invention relates to a wavefront aberration measuring device for measuring the wavefront aberration of an optical system including, for example, a projection optical system for EUVL (Extreme Ultra-Violet Lithography), a projection exposure apparatus which is provided with a projection optical system, a method for manufacturing a projection optical system, and a method for manufacturing a device.

2. Description of the Related Art

The projection optical system for EUVL is mainly constructed of those based on the catoptric type. Therefore, it is assumed that the principle of the shearing interference is applied to the measurement of the wavefront. aberration (see, for example, Japanese Patent Application Laid-open No. 2003-86501).

In this wavefront aberration measurement, a mask is arranged on the object plane of an optical system to be inspected (inspection-objective optical system). A minute aperture (pin hole) is provided for the mask. When the mask is illuminated, an ideal spherical wave is generated. When the generated wave is used as a measuring light (measuring light beam) coming into the inspection-objective optical system, a light (light beam), in which the wavefront is strained due to the wavefront aberration of the inspection-objective optical system, exits from the inspection-objective optical system. The light beam is sheared (subjected to the lateral deviation), by a diffraction grating placed on the back side focal plane of the inspection-objective optical system, to form the interference fringe on a CCD image pickup element. When the interference fringe is analyzed by the phase shift method or the Fourier transformation method (see, for example, “Applied Optics”, Vol. 23, 1760, 1984), it is possible to know the wavefront aberration.

In the case of this measurement, a low-luminance light source, which includes a laser plasma light source (LPP: Laser Produced Plasma) and a discharge plasma light source (DPP: Discharge Produced Plasma), is used as the EUV light source. Therefore, when the light is restricted by the pin hole, then the light amount of the measuring light beam is insufficient, and the luminance of the interference fringe is insufficient as well. Therefore, it is difficult to effect the detection.

For this reason, it is conceived that a slit, which has a width equivalent to the diameter of the pin hole and which is long in the non-shearing direction, is used in place of the pin hole to gain the light amount. The wavefront of the light generated by the slit does not form an ideal spherical surface in the longitudinal direction of the slit. However, when at least two interference fringes are detected by changing the direction of arrangement of the diffraction grating and the slit, it is expected to obtain information about the wavefront aberration.

However, it is impossible to fill the entire pupil of the inspection-objective optical system with the measuring light beam, because the slit does not diffract the light in the longitudinal direction. In such a situation, it is impossible to bring about any satisfactory interference fringe which includes the necessary information.

In order to avoid this problem, it is appropriate that the illumination sigma value on the mask is defined to be 1. However, the sigma value has a limit of 0.8 in view of the design of the illumination system. It is also conceived that the angle of the light for illuminating the mask therewith is varied to apparently improve the sigma value. However, in this case, the load is increased upon the design of the illumination system.

### SUMMARY OF THE INVENTION

According to a first aspect exemplifying the present invention, there is provided a wavefront aberration measuring device comprising a mask which arranges a group of minute apertures for generating a group of point light sources at an object point as a measurement objective of an inspection-objective optical system; an illumination system which illuminates the mask with an illumination light; a diffraction grating which shears, into a plurality of light fluxes, a light flux exiting from the group of minute apertures and passing via the inspection-objective optical system; and a detecting portion which detects an interference fringe formed mutually by the plurality of sheared light fluxes, wherein the following expression holds:

(Pg²/λ)×(N−0.2)≦Lg≦(Pg²/λ)×(N+0.2)

wherein Lg represents a displacement amount from a back side focal plane of the inspection-objective optical system to the diffraction grating, Pg represents a grating pitch of the diffraction grating, λ represents a wavelength of the illumination light, and N represents an arbitrary natural number.

According to the first aspect exemplifying the present invention, the wavefront aberration measuring device is realized, which makes it possible to reliably obtain the information about the wavefront aberration of the inspection-objective optical system.

According to a second aspect exemplifying the present invention, there is provided a wavefront aberration measuring device comprising a mask which arranges a group of minute apertures for generating a group of point light sources at an object point as a measurement objective of an inspection-objective optical system; an illumination system which illuminates the mask with an illumination light; a diffraction grating which shears, into a plurality of light fluxes, a light flux exiting from the group of minute apertures and passing via the inspection-objective optical system; and a detecting portion which detects an interference fringe formed mutually by the plurality of sheared light fluxes; wherein a center spacing distance L between adjacent minute apertures which are adjacent in a shear direction in the group of minute apertures is defined to minimize a coherence degree.

According to the second aspect exemplifying the present invention, the wavefront aberration measuring device is realized, which makes it possible to reliably obtain the information about the wavefront aberration of the inspection-objective optical system.

According to a third aspect exemplifying the present invention, there is provided a projection exposure apparatus comprising a projection optical system which transfers a pattern of an exposure mask to an exposure objective; an exposure illumination system which illuminates the exposure mask; and the wavefront aberration measuring device, as defined in any one of the foregoing aspects, which measures a wavefront aberration of the projection optical system.

According to the third aspect exemplifying the present invention, the projection exposure apparatus is realized, which makes it possible to reliably obtain the information about the wavefront aberration of the projection optical system.

According to a fourth aspect exemplifying the present invention, there is provided a method for manufacturing a projection optical system, comprising a step of measuring a wavefront aberration of the projection optical system by using the wavefront aberration measuring device as defined in any one of the foregoing aspects; and a step of adjusting the projection optical system depending on a result of the measurement.

According to the fourth aspect exemplifying the present invention, the method for manufacturing the projection optical system is realized, which makes it possible to reliably manufacture the high performance projection optical system.

According to a fifth aspect exemplifying the present invention, there is provided a method for manufacturing a device, comprising exposing a substrate by using the projection exposure apparatus as defined in the foregoing aspect; and developing the exposed substrate.

According to the fifth aspect exemplifying the present invention, the device can be manufactured by using the exposure apparatus which makes it possible to satisfactorily expose the substrate.

### BRIEF DESCRIPTION OF THE DRAWINGS

FIG. 1 shows a schematic arrangement illustrating a projection exposure apparatus for EUVL provided with the function to measure the wavefront aberration.

FIGS. 2A and 2B illustrate aperture patterns and grating patterns of a first embodiment.

FIG. 3 illustrates an aperture pattern of a second embodiment.

FIG. 4 is a view for explaining, for example, Lg and Lc.

FIG. 5 illustrates an aperture pattern of a third embodiment.

FIG. 6 shows the relationship between the ratio of the width W (duty ratio) and the interference fringe intensity.

FIG. 7 illustrates an aperture pattern of a fourth embodiment.

FIG. 8 illustrates a grating pattern of the fourth embodiment.

FIG. 9 shows a modified embodiment of the aperture pattern of the fourth embodiment.

FIG. 10 shows another modified embodiment of the aperture pattern of the fourth embodiment.

FIG. 11 shows a curve of the coherence degree with respect to the distance between two points on a measuring reflection type mask 20.

FIG. 12 shows a partial magnified view illustrating dot groups of the third embodiment (FIG. 5).

FIG. 13 shows a partial magnified view illustrating dot groups of the fourth embodiment (FIGS. 7, 9, and 10).

FIG. 14 shows a schematic arrangement illustrating a wavefront aberration measuring device using a light source X₀ having low space coherence, a light-collecting mirror M1, and a transmission type mask M′.

FIG. 15 shows a flow chart illustrating a procedure of a method for manufacturing a projection optical system of a fifth embodiment.

FIG. 16 shows total numbers of dots when Example 1 is adapted to the second embodiment (FIG. 3), the third embodiment (FIG. 5), the fourth embodiment (FIG. 7), and the fourth embodiment (FIGS. 9 and 10).

FIG. 17 shows a flow chart illustrating exemplary steps of producing a microdevice.

A general architecture that implements the various features of the invention will be described with reference to the drawings. The drawings and the associated description are provided to illustrate embodiments of the invention and not to limit the scope of the invention.

### DESCRIPTION OF THE PREFERRED EMBODIMENTS

Embodiments of the present invention will be explained below with reference to the drawings. However, the present invention is not limited thereto.

### First Embodiment

A first embodiment is explained. This embodiment relates to a projection exposure apparatus for EUVL provided with the function to measure the wavefront aberration. The wavefront aberration is measured, for example, at an appropriate timing during the operation of the projection exposure apparatus.

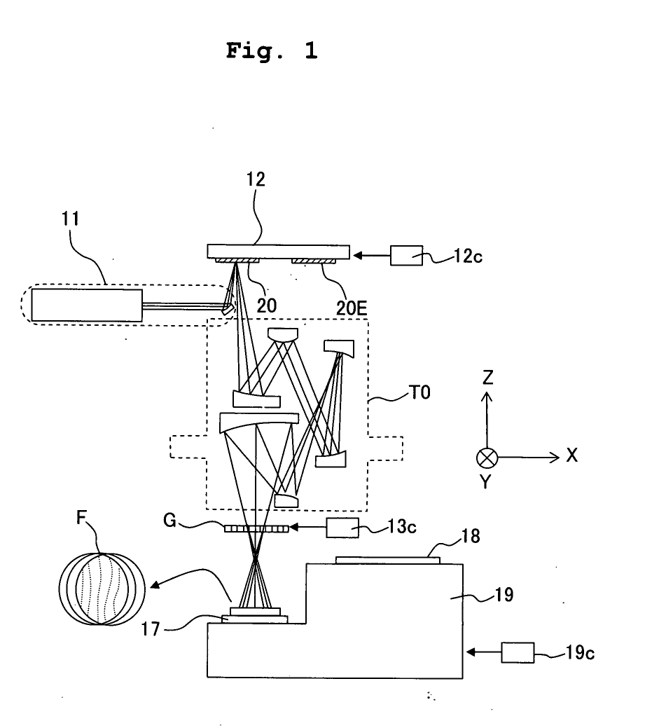

FIG. 1 shows a schematic arrangement of the apparatus of this embodiment.

As shown in FIG. 1, the apparatus of this embodiment includes an illumination optical system 11 for EUVL, a mask stage 12, a measuring reflection type mask 20, a driving mechanism 12c for the mask stage, a projection optical system TO for EUVL, a diffraction grating G, a driving mechanism 13c for the diffraction grating, a CCD image pickup element 17, a wafer stage 19, a driving mechanism 19c for the wafer stage, and the like.

The measuring reflection type mask 20 is supported, for example, by the mask stage 12 together with an exposure reflection type mask 20E, and is inserted into the optical path of the apparatus of this embodiment (object plane of the projection optical system TO) during only the measurement. FIG. 1 shows a situation brought about when the measurement is performed.

The diffraction grating G is inserted into the optical path of the apparatus of this embodiment (on the image side of the projection optical system TO) during only the measurement. The plane of insertion is deviated by a predetermined distance from the image plane (back side focal plane) of the projection optical system TO.

The CCD image pickup element 17 is supported, for example, by the wafer stage 19 together with the substrate (wafer) 18, which is inserted into the optical path of the apparatus of this embodiment (on the back side from the image plane and the diffraction grating G) during only the measurement.

The illumination optical system 11 includes a EUV light source constructed of LPP, DPP or the like. The light source has the low space coherence. The illumination optical system 11 effects the Koehler illumination for the exposure reflection type mask 20E with a EUV light beam (for example, a EUV light beam having a wavelength of 13.5 nm) emitted from the EUV light source during the exposure. Further, the illumination optical system 11 illuminates the measuring reflection type mask 20 during the measurement. The apparatus of this embodiment may be provided with an illumination optical system for the measurement. However, in this case, the illumination optical system 11 is used as it is for the measurement.

When the measuring reflection type mask 20 is illuminated during the measurement, measuring light flux is generated at an aperture on the measuring reflection type mask 20. When the measuring light flux is allowed to come into the projection optical system TO, then the light flux passes via each of optical surfaces of the projection optical system TO, and then the light flux is allowed to exit to the image side of the projection optical system TO as the wavefront or wave surface including information about the wavefront aberration of the projection optical system TO. The light flux is allowed to come into the CCD image pickup element 17 via the diffraction grating G. The light flux, which is allowed to come into the diffraction grating G, is sheared (laterally deviated) into a plurality of diffracted light beams. Therefore, an interference fringe (shearing interference fringe) F, which is formed mutually by the diffracted light beams, appears on the CCD image pickup element 17. The interference fringe F is photographed or imaged by the CCD image pickup element 17. An image data (luminance distribution information about the interference fringe F), which is outputted from the CCD image pickup element 17, is inputted to an unillustrated computer.

The interference fringe F is detected as described above in a state in which the shear direction (direction of lateral deviation) is defined in the X direction and a state in which the shear direction is defined in the Y direction respectively. In order to define the shear direction in the X direction, it is appropriate that the direction of grating lines of the diffraction grating G is defined in the Y direction. In order to define the shear direction in the Y direction, it is appropriate that the direction of grating lines of the diffraction grating G is defined in the X direction. FIG. 1 shows a situation in which the shear direction is defined in the X direction.

The direction of arrangement of the aperture pattern of the measuring reflection type mask 20 also differs by 90° between the situation in which the shear direction is the X direction and the situation in which the shear direction is the Y direction. Details thereof will be described later on.

The unillustrated computer determines the shape of the wavefront (shear wavefront in the X direction) corresponding to the interference fringe F on the basis of the image data of the interference fringe F detected by defining the shear direction in the X direction. For example, the phase shift method, the Fourier transformation method or the like is applied thereto. When the phase shift method is applied, it is appropriate that the image data of the interference fringe F, which amounts for a plurality of frames, is obtained while shifting the phase of the interference fringe F, for example, by finely moving the diffraction grating G in the shear direction (X direction).

Similarly, the computer determines the shape of the shear wavefront in the Y direction on the basis of the image data of the interference fringe F detected by defining the shear direction in the Y direction.

Further, the computer determines the wavefront aberration of the projection optical system TO on the basis of the shear wavefront in the X direction and the shear wavefront in the Y direction. In this procedure, for example, the differential Zernike fitting method, the integration method or the like is applied.

In the apparatus of this embodiment, it is preferable to satisfy the following expression (1):

Lg=(Pg²/λ)×N (1)

wherein Lg represents the displacement amount from the image plane of the projection optical system TO to the diffraction grating G, Pg represents the grating pitch of the diffraction grating G, λ represents the measuring wavelength, and N represents an arbitrary natural number.

The expression (1) is also referred to as “Talbot condition”, which is the conditional expression to form the Fourier image of the diffraction grating G on the CCD image pickup element 17. In the expression (1), the distance from the diffraction grating G to the CCD image pickup element 17 is regarded to be sufficiently longer than Lg. Details of the Talbot condition are described in “Applied Optics 1 (Tsuruta)” (pp. 178-181, Baihukan, 1990).

If the expression (1) is satisfied, the pattern of the interference fringe F formed on the CCD image pickup element 17 has a clear stripe-shaped form. Therefore, the shear wavefront can be obtained highly accurately by the Fourier transformation method or the phase shift interference method described above.

If the expression (1) is not satisfied, and the arrangement surface of the diffraction grating G is coincident with the image plane (Lg=0), then the pattern of the interference fringe F has a blurred one-color. Therefore, it is impossible to apply the Fourier transformation method, and only the phase shift method can be applied.

On the other hand, even if the expression (1) is not satisfied completely, if the arrangement plane of the diffraction grating G is deviated merely slightly from the position at which the expression (1) is satisfied, then the Fourier image is formed. Therefore, it is possible to analyze the shear wavefront. The allowable range of the deviation amount is about ±20%.

Therefore, actually, it is enough that the following expression (2) is satisfied in place of the expression (1).

(Pg²/λ)×(N−0.2)≦Lg≦(Pg²/λ)×(N+0.2) (2)

The diffraction grating G may be arranged on the back side of the image plane (on the side of the CCD image pickup element 17). Alternatively, the diffraction grating G may be arranged on the front side of the image plane (on the side of the projection optical system TO).

Next, an explanation will be made about the aperture pattern of the measuring reflection type mask 20.

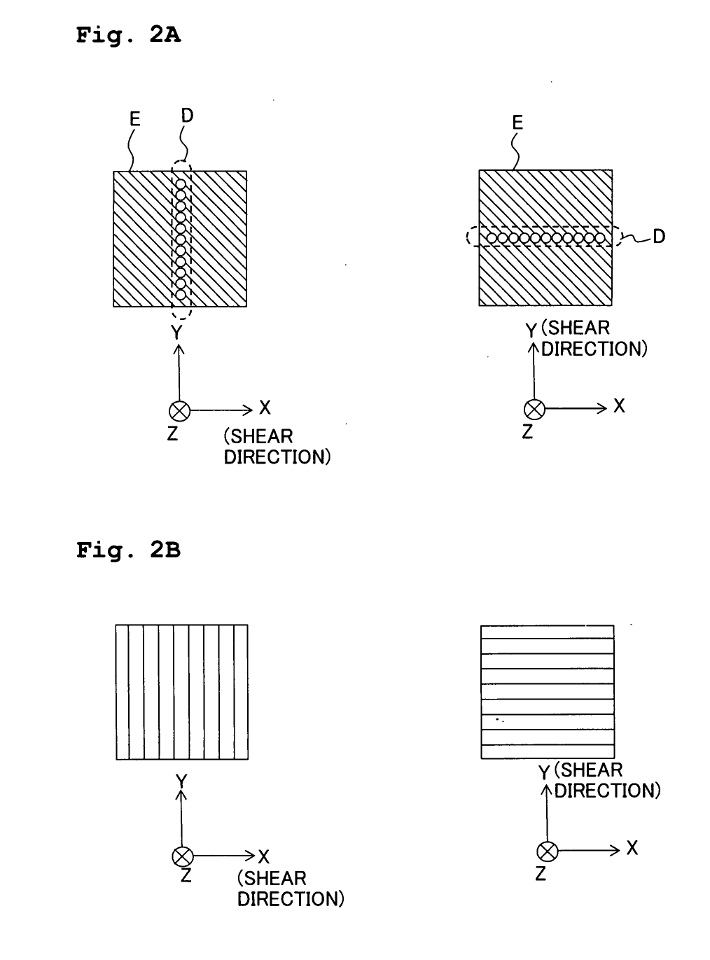

FIG. 2A shows a plan view illustrating the aperture pattern of the measuring reflection type mask 20. The aperture pattern, which is used when the shear direction is the X direction, is shown on the left side of FIG. 2A. An area E indicates an area corresponding to one object point as the measurement objective.

As shown in FIG. 2A, the aperture pattern is formed of a group of dots D (dot group D) arranged linearly in the non-shear direction (Y direction). In FIG. 2A, the dots are depicted in a number smaller than an actual number.

The diameter of the individual dot (dot diameter) Φ satisfies, for example, an expression of Φ<λ/(2NA)/M in order to generate the ideal spherical wave. However, λ represents the measuring wavelength, NA represents the numerical aperture of the projection optical system TO, and M represents the magnification of the projection optical system TO. For example, when λ=13.5, NA=0.25, and M=¼ are given, Φ<108 nm is provided.

The grating pattern (grating pattern to allow the shear direction to be in the X direction), which is used together with the aperture pattern, has the grating lines which are coincident with the non-shear direction (Y direction) as shown on the left side in FIG. 2B. In FIG. 2, the grating lines are depicted in a number smaller than an actual number.

When the dot group D as described above is used, it is possible to gain the light amount substantially in the same manner as the slit which is long in the Y direction. Therefore, it is possible to enhance the light amount of the interference fringe F, and it is possible to enhance the calculation accuracy for the shear wavefront.

Further, the dot group D diffracts the light beam also in the non-shear direction (Y direction), unlike the slit. Therefore, even when the illumination sigma value is small on the mask, it is possible to fill the entire pupil of the projection optical system TO with the measuring light flux. Therefore, all of the necessary information is reflected on the interference fringe F.

The aperture pattern, which is used when the shear direction is the Y direction, is as shown on the right side in FIG. 2A. The grating pattern, which is used together therewith, is as shown on the right side in FIG. 2B.

As described above, according to the apparatus of this embodiment, it is possible to reliably obtain the information about the wavefront aberration of the projection optical system TO, although the light source is the low luminance light source such as LPP or DPP.

### Second Embodiment

A second embodiment will be explained. Only the difference from the first embodiment will now be explained. The difference between the second and first embodiments is in the aperture pattern of the measuring reflection type mask 20. The aperture pattern to be used when the shear direction is the X direction and the aperture pattern to be used when the shear direction is the Y direction are different from each other in only the direction of arrangement by 90°. Therefore, only the former will now be explained.

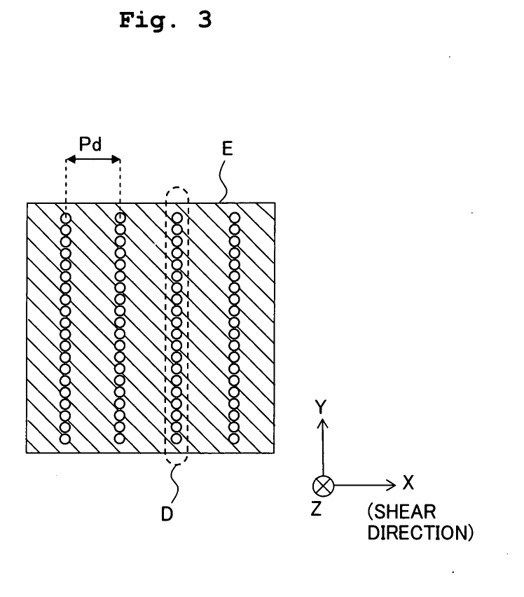

FIG. 3 illustrates the aperture pattern (for the measurement in the X direction) of this embodiment. The area E indicates an area corresponding to one object point as the measurement objective.

As shown in FIG. 3, in this aperture pattern, a plurality of dot groups D, which are aligned linearly in the non-shear direction (Y direction), are periodically arranged in the shear direction (X direction) with spacing distances.

An arrangement pitch Pd of the dot groups D is sufficiently larger than the coherence distance on the mask. Therefore, the respective interference fringes, which are individually formed by the plurality of dot groups D, are overlapped with each other incoherently on the CCD image pickup element 17.

Further, the arrangement pitch Pd of the dot groups D corresponds to the pitch obtained by projecting the grating pitch Pg of the diffraction grating G onto the object plane. That is, the following expression (3) is satisfied.

Pd=(1/M)×Pg (3)

For example, when the grating pitch Pg of the diffraction grating G=1 μm and the magnification M of the projection optical system TO=¼ are given, it is appropriate to make the setting of the arrangement pitch Pd=4 μm.

On this assumption, the phases of the respective interference fringes individually formed by the plurality of dot groups D are substantially coincident with each other. Therefore, the light amount is increased for the interference fringes F on the CCD image pickup element 17 by an amount corresponding to the provision of the plurality of dot groups D while hardly lowering the contrast.

However, correctly speaking, the phases of the respective interference fringes individually formed by the plurality of dot groups D are slightly deviated from each other. In order to completely suppress the slight deviation, it is appropriate to use the following expression (4) in place of the expression (3).

Pd=(1/M)×{Pg/(1−Lg/Lc)} (4)

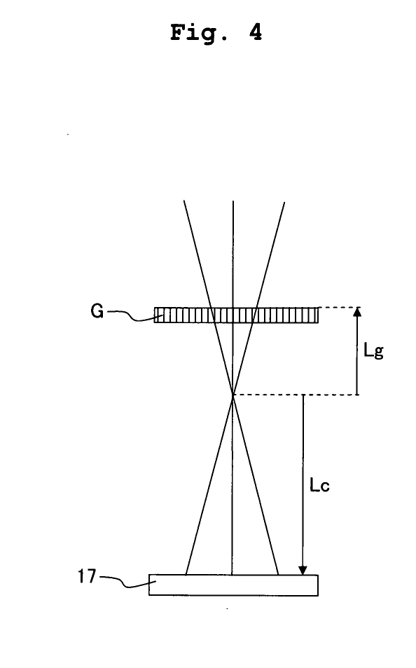

In the expression (4), as shown in FIG. 4, Lg represents the displacement amount from the image plane of the projection optical system TO to the diffraction grating G, and Lc represents the displacement amount from the image plane of the projection optical system TO to the CCD image pickup element 17. On this assumption, when the diffraction grating G is arranged on the back side of the image plane, (Lg/Lc) has a positive value. When the diffraction grating G is arranged on the front side of the image plane, (Lg/Lc) has a negative value.

When the expression (4) is used, it is possible to more reliably avoid the decrease in the contrast of the interference fringe F.

In this embodiment, the expression (3) or the expression (4) is satisfied. Therefore, the arrangement pitch of the images of the plurality of dot groups D are substantially coincident with the grating pitch Pg.

Therefore, if the expression (2) is not satisfied in this embodiment, and the arrangement plane of the diffraction grating G is coincident with the image plane (i.e., Lg=0 is given), then the grating of the diffraction grating G is overlapped with the light portion and the shade portion of the image of the dot group D at approximately the same cycle or period. In this case, not only the pattern of the interference fringe F has one-color, but the color (brightness) of the interference fringe F is greatly changed when any minute image displacement arises. Therefore, the pattern of the interference fringe F is unstable.

Further, when the interference fringe F has one-color, only the phase shift method can be applied to obtain the shear wavefront. For this reason, when the diffraction grating G is finely moved, the image displacement is also caused to a certain extent. Therefore, the fluctuation of the light and shade due to the phase shift and the fluctuation of the light and shade due to the image displacement are simultaneously caused in the pattern of the interference fringe F. Even when such an interference fringe F is detected, it is difficult to separate and extract the fluctuation component brought about by the image displacement and the fluctuation component brought about by the phase shift.

Therefore, it is extremely important to satisfy the expression (2) in this embodiment in order not to substantially disable the measurement of the wavefront aberration as well.

### Third Embodiment

A third embodiment will be explained. Only the difference from the second embodiment will now be explained. The difference between the third and second embodiments is in the aperture pattern of the measuring reflection type mask 20. The aperture pattern to be used when the shear direction is the X direction and the aperture pattern to be used when the shear direction is the Y direction are different from each other in only the direction of arrangement by 90°. Therefore, only the former will now be explained.

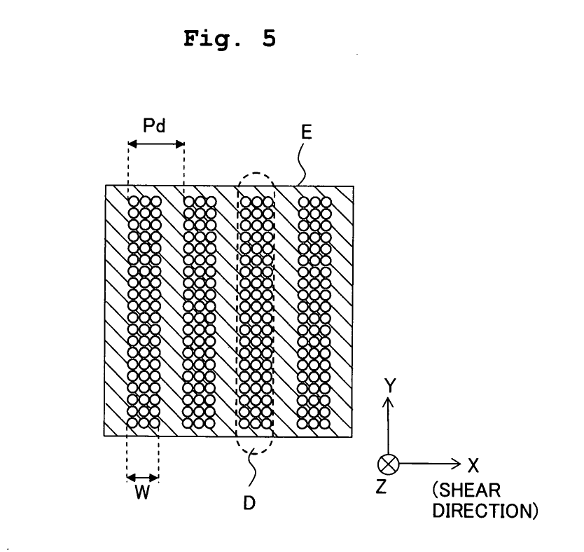

FIG. 5 illustrates the aperture pattern (for the measurement in the X direction) of this embodiment. An area E indicates an area corresponding to one object point as the measurement objective.

As shown in FIG. 5, in the aperture pattern of this embodiment, a plurality of groups of dots (dot groups) D, which are aligned in a band-shaped form long in the non-shear direction (Y direction), are periodically arranged with spacing distances therebetween in the shear direction (X direction). The arrangement pitch Pd of the dot groups D satisfies the expression (3) or the expression (4).

When the aperture pattern as described above is adopted, it is possible to increase the light amount corresponding to the provision of the band-shaped form of the area for forming the dot groups D, although the contrast of the interference fringe F is lowered.

For example, the setting is made to give the arrangement pitch Pd of the dot groups D=4 μm, the dot diameter Φ=100 nm, the center spacing distance between adjacent dots which are adjacent in the dot group D=200 nm, and the width W in the shear direction of the dot group D=2 μm. On this assumption, the number of dots in the shear direction in the dot group D can be increased to about 10. If the width of the area E is 200 μm, the dot groups D, which are formed of 10×1,000=10,000 dots, can be arranged in 50 cycles in the area E. In this case, the total number of the dots in the area E is 500,000.

Therefore, according to this embodiment, the light amount can be increased 500,000 times than a case in which the measurement is performed with the single aperture, although the contrast of the interference fringe F is lowered.

The reason, why the contrast of the interference fringe F is lowered in this embodiment, is as follows. That is, the interference fringes, which are formed by the plurality of dots arranged at the arrangement pitch Pd to satisfy the expression (3) or the expression (4), are coincident with each other in relation to the phase. However, the phases are deviated from each other between the interference fringes formed by the plurality of dots arranged at any arrangement pitch deviated from the arrangement pitch Pd. Further, as the deviation of the arrangement pitch is larger, the deviation of the phase becomes larger.

For this reason, the contrast is improved as the width W of the dot group D in the shear direction approaches the dot diameter Φ more closely, and the light amount is increased as the width W of the dot group D in the shear direction approaches the arrangement pitch Pd more closely. Therefore, it is desirable that the width W is selected to have an appropriate size to such an extent that the amount of decrease in the contrast causes no problem.

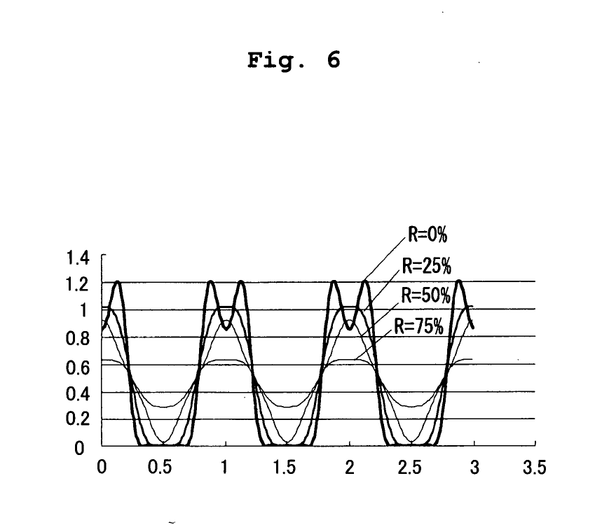

FIG. 6 shows the relationship between the ratio of the width W with respect to the arrangement pitch Pd (duty ratio R=W/Pd) and the interference fringe intensity. FIG. 6 shows the interference fringe intensities for four cases of the duty ratio R=0%, 25%, 50%, and 75%. In this case, the diffracted light beams having the orders equal to or higher than the 2 nd order generated by the diffraction grating G are neglected.

As clarified in FIG. 6, it is appreciated that the contrast is the highest in the case of the duty ratio R=0%, and the contrast is the lowest in the case of the duty ratio R=75%. However, the contrast, which is constant to a certain extent, is obtained even in the case of the duty ratio R=75%.

Therefore, it is appropriate that the width W of the dot group D in the shear direction is selected so that the duty ratio R=W/Pd is within a range of 0% to 80%. In other words, the width W of the dot group D in the shear direction and the arrangement pitch Pd satisfy at least the following expression (5).

W/Pd<0.8 (5)

### Fourth Embodiment

A fourth embodiment will be explained. Only the difference from the third embodiment (see FIG. 5) will now be explained. The difference between the fourth and third embodiments is that the interference fringe to be obtained when the shear direction is set to the X direction and the interference fringe to be obtained when the shear direction is set to the Y direction are simultaneously detected. Therefore, in this embodiment, the aperture pattern of the measuring reflection type mask 20 and the grating pattern of the diffraction grating G are two-dimensional patterns respectively.

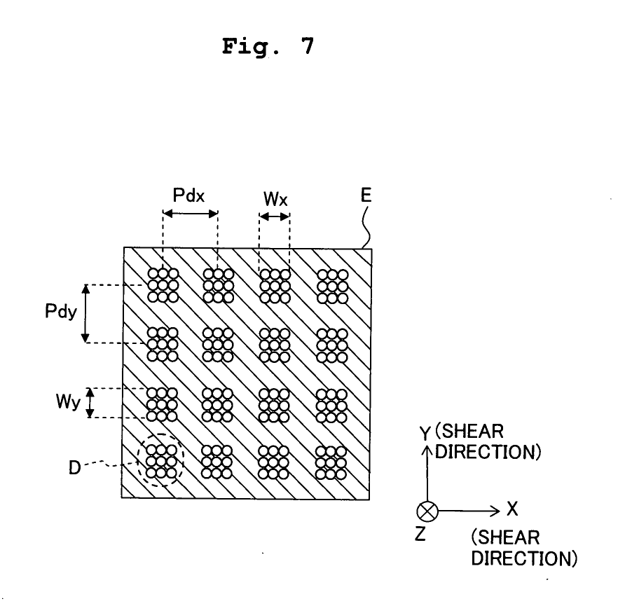

FIG. 7 shows the aperture pattern of this embodiment. An area E indicates an area corresponding to one object point as the measurement objective.

As shown in FIG. 7, in the aperture pattern of this embodiment, a plurality of group of dots (dot groups) D, which are aligned in a square form, are periodically arranged with spacing distances therebetween in the two shear directions (in the X direction and the Y direction).

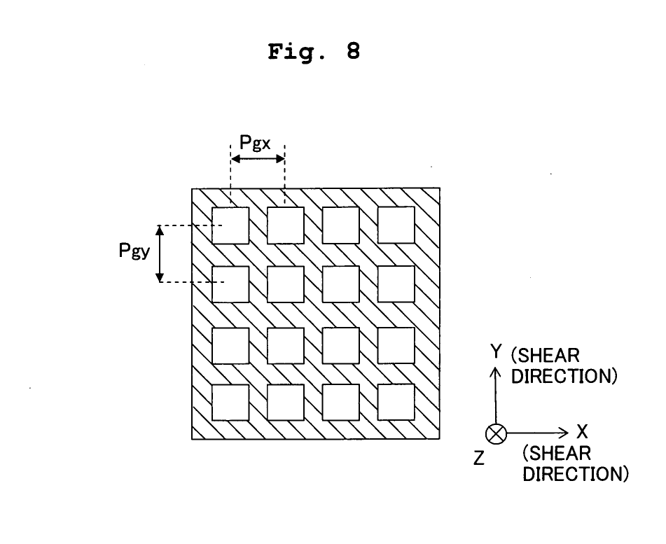

As shown in FIG. 8, the grating pattern (grating pattern to allow the shear direction to be the X direction and the Y direction), which is used together with the aperture pattern, is a grid-shaped pattern in which the gratings are coincident with the two shear directions (X direction and Y direction).

The arrangement pitch Pdₓ in one shear direction (X direction) of the dot groups D and the grating pitch Pgₓ in the same direction (X direction) of the grating pattern satisfy the same condition as that for Pd and Pg in the third embodiment.

The arrangement pitch Pd_{Y} in the other shear direction (Y direction) of the dot groups D and the grating pitch Pg_{y} in the same direction (Y direction) of the grating pattern satisfy the same condition as that for Pd and Pg in the third embodiment.

The width Wₓ in one shear direction (X direction) of the dot groups D and the arrangement pitch Pdₓ satisfy the same condition as that for W and Pd in the third embodiment.

The width W_{Y} in the other shear direction (Y direction) of the dot groups D and the arrangement pitch Pd_{Y} satisfy the same condition as that for W and Pd in the third embodiment.

When the shear ratio in the X direction is the same as the shear ratio in the Y direction, it is possible to suppress the calculation load on the computer. Therefore, it is desirable to provide Pg_{X}=Pg_{Y}. On this assumption, there are given Pd_{X}=Pd_{Y} and W_{X}=W_{Y}.

When the aperture pattern and the grating pattern as described above are utilized, it is possible to simultaneously and reliably detect the interference fringe to be obtained when the shear direction is set to the X direction and the interference fringe to be obtained when the shear direction is set to the Y direction.

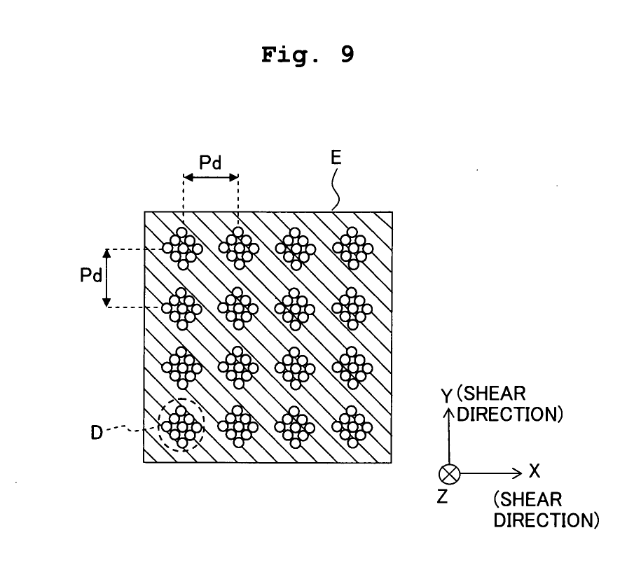

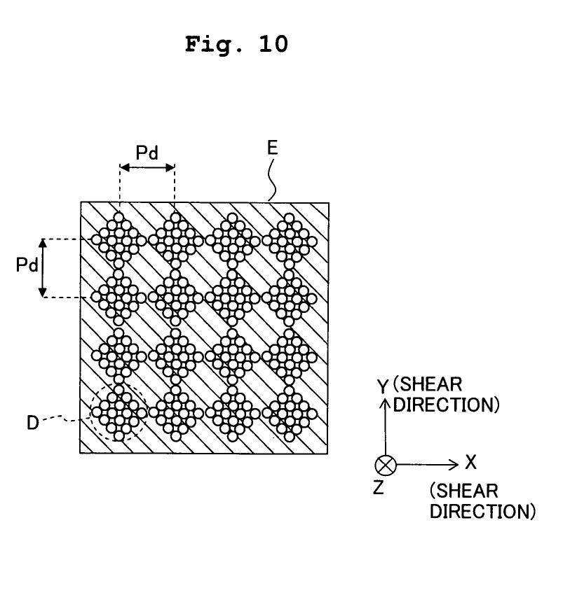

As shown in FIG. 9, the direction of arrangement of each of the dot groups D may be rotated by 45° so that the area for forming the dot groups D may be checkerboard-shaped. In this case, for example, as shown in FIG. 10, it. is possible to increase the number of dots as well, which is advantageous to increase the light amount.

### About Center Spacing Distance Between Adjacent Dots In Dot Group

An explanation will be made about the center spacing distance between adjacent dots which are adjacent in the dot group.

First, it is advantageous in view of the light amount that the center spacing distance between the adjacent dots in the dot group is as narrow as possible, because it is possible to arrange a large number of dots. However, if the center spacing distance is too narrow, there is such a possibility that the adjacent or adjoining dots interfere with each other, and any variation in intensity (noise) at the low frequency and/or the speckle are/is superimposed on the interference fringe.

On the other hand, the component in the non-shear direction, which is included in the luminance distribution of the interference fringe, is unnecessary for calculating the wavefront aberration. Therefore, no problem arises even when the noise is superimposed on the interference fringe in the case of only the non-shear direction. Therefore, it is desirable that the center spacing distance between the adjacent dots in the non-shear direction in the dot group is as narrow as possible (i.e., approximate to the dot diameter), and it is desirable that the center spacing distance between the adjacent dots in the shear direction in the dot group is defined to such an appropriate distance that the coherence is lowered.

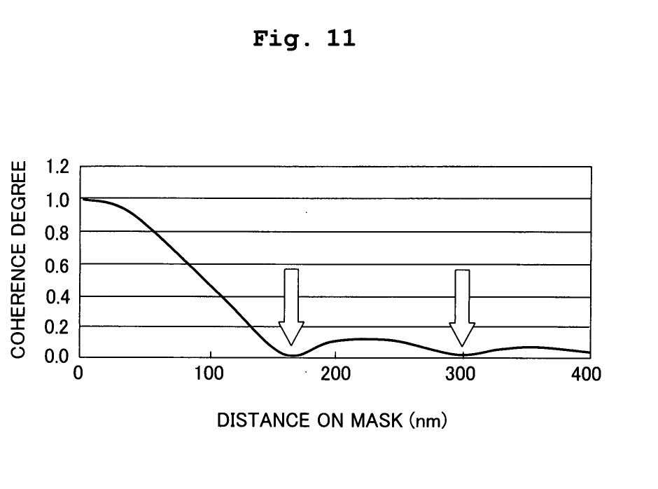

FIG. 11 shows a curve of the coherence degree with respect to the distance between two points on the measuring reflection type mask 20. This curve is obtained under the condition of the numerical aperture NA′ of the illumination optical system=0.0625, the illumination sigma value σ=0.8, and the measuring wavelength λ=13.5.

When the curve shown in FIG. 11 is roughly inspected, the coherence degree is lowered as the distance between two points is widened. However, when the curve is inspected in detail, it is understood that there is such a possibility that the coherence degree becomes zero even when the distance between two points is narrow. With reference to FIG. 11, the coherence degree is minimized when the distance is 164 nm and 302 nm.

Therefore, under this condition, it is appropriate to make the setting of L=164 nm or L=302 nm for the center spacing distance L between the adjacent dots in the shear direction in the dot group.

Under general conditions, this curve is represented by the linear Bessel function of the first kind, the measuring wavelength λ, the numerical aperture NA′ of the illumination optical system, and the illumination sigma value a. Assuming that the zero point of the linear Bessel function of the first kind J₁(X) is X₀ (=3.732, 7.06, 10.174, . . . ), the curve is minimized when the distance=X₀/(2π)×λ/σNA′ is given.

Therefore, it is enough that the center spacing distance L between the adjacent dots in the shear direction in the dot group satisfies the following expression (6).

L={X₀/(2π)}×{λ/σ×NA′)} (6)

In particular, when L is set to have the value given by the smaller zero point (X₀=3.732 or X₀=7.06), it is possible to enhance the arrangement density of the dots while avoiding the noise at the low frequency and the speckle.

The foregoing fact is adapted to the respective embodiments as follows.

At first, in the first embodiment (FIG. 2) and the second embodiment (FIG. 3), the interference fringe to be obtained when the shear direction is set to the X direction and the interference fringe to be obtained when the shear direction is set to the Y direction are detected distinctly. The plurality of dots are arranged in only the non-shear direction in the dot group D.

Therefore, in the first embodiment (FIG. 2) and the second embodiment (FIG. 3), the center spacing distance L between the adjacent dots in the dot group may be set to a narrow distance (100 nm to 150 nm) approximately equivalent to the dot diameter Φ. However, in actuality, if the dots make contact with each other, then the light leakage arises between the mutually adjoining dots, and it is impossible to cause the diffraction wave independently. Therefore, it is desirable that the center spacing distance L between the adjacent dots in the dot group is 120 to 150 nm which is slightly larger than the dot diameter Φ.

In another viewpoint, in the third embodiment (FIG. 5), the interference fringe to be obtained when the shear direction is set to the X direction and the interference fringe to be obtained when the shear direction is set to the Y direction are detected distinctly. The plurality of dots are arranged in both of the shear direction and the non-shear direction in the dot group D.

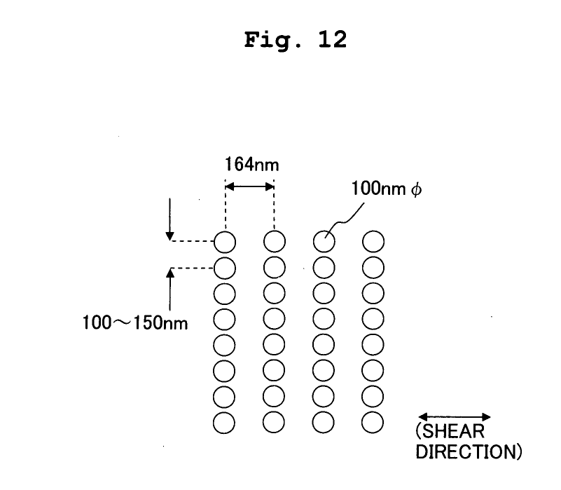

Therefore, in the third embodiment (FIG. 5), it is appropriate that the center spacing distance L between the adjacent dots in the shear direction in the dot group is set to provide such a distance (164 nm) that the coherence degree is zero, and the center spacing distance L between the adjacent dots in the non-shear direction in the dot group is set to provide a narrow distance (100 nm to 150 nm) approximately equivalent to the dot diameter Φ (However, in actuality, it is desirable that the distance is 120 to 150 nm which is slightly larger than the dot diameter Φ). An example of the arrangement of dots as described above is shown in FIG. 12.

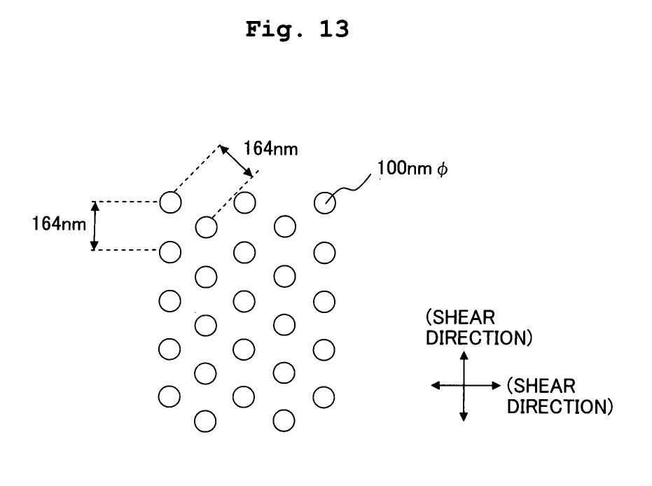

In still another viewpoint, in the fourth embodiment (FIGS. 7, 9, and 10), the interference fringe to be obtained when the shear direction is set to the X direction and the interference fringe to be obtained when the shear direction is set to the Y direction are simultaneously detected. The plurality of dots are arranged in both of the two shear directions (X direction and Y direction) in the dot group D. Therefore, in the fourth embodiment (FIGS. 7, 9, and 10), the center spacing distance L between the adjacent dots in the two shear directions (X direction and Y direction) in the dot group is set to a distance of 164 nm at which the coherence degree is zero, respectively. An example of the dot arrangement as described above is shown in FIG. 13. In FIG. 13, the dot arrangement has a triangular lattice-shaped form. When this arrangement is adopted, then the design is easily performed, and it is possible to gain the number of dots.

The center spacing distance between the adjacent dots in the dot group as described above is not limited to the wavefront aberration measuring device in which the diffraction grating G is arranged at the position which satisfies the expression (2), and is also widely applicable, for example, to wavefront aberration measuring devices of other measuring systems.

### About Dot Diameter

An additional explanation will be made about the dot diameter in the respective embodiments described above.

In the description, the dot diameter Φ satisfies the expression of Φ<λ/(2NA)/M. However, the dot diameter Φ can be also defined to be somewhat large within a range in which the entire pupil of the optical system TO to be inspected is filled with the measuring light flux.

For example, in the case of the object side numerical aperture NA of the projection optical system TO=0.0625 and the illumination sigma value σ=0.8, the entire pupil is filled provided that the wavefront is widened to an extent of 0.0625×0.2=0.0125. Therefore, it is also possible to increase the dot diameter σ to some extent.

However, if the dot diameter σ is too large, then it is impossible to completely remove the aberration of the illumination optical system 11, and the wavefront of the measuring light flux is disturbed. Due to this, there is such a possibility that the accuracy of the wavefront aberration measurement is lowered.

Therefore, in order to fill the entire pupil and avoid the disturbance of the wavefront, it is desirable that the dot diameter σ is in a range of about σ=150 to 200 nm. For example, when the arrangement pattern shown in FIG. 13 is adopted, and there is given σ=from 100 nm to σ=150 nm, then it is possible to double the light amount of the interference fringe F while suppressing the disturbance of the wavefront.

When the disturbance of the wavefront is permitted, then the condition for the dot diameter σ is mitigated, and there is given σ<λ/{2×NA×(1−σ)}˜540 nm. However, in this case, it is necessary to perform the calibration in order to remove the remaining aberration. For example, when the setting is made to give the dot diameter σ=100 nm, and the wavefront for the calibration is measured beforehand, then it is possible to suppress the decrease in the measurement accuracy which would be otherwise caused by the disturbance of the wavefront, by using the data of the wavefront for the calibration, even when the setting is made to give the dot diameter σ=540 nm in the ordinary measurement.

### Other Features

In the respective drawings described above, the dot arrangement in the dot group D is regular. However, it is also allowable that the dot arrangement is random.

In the respective embodiments described above, the reflection type mask is used. However, it is also possible to utilize a transmission type mask having a similar aperture pattern (the aperture of the transmission type mask is formed of a transmission surface for transmitting the light, whereas the aperture of the reflection type mask is formed of a reflection surface for reflecting the light).

In the respective embodiments described above, the illumination optical system of the projection exposure apparatus is used as it is for the measurement of the wavefront aberration. However, the measurement of the wavefront aberration can be similarly performed by using at least a light source having low space coherence and a light-collecting optical system for collecting, onto the mask, the light flux allowed to exit from the light source.

In the respective embodiments described above, the projection exposure apparatus for EUVL is explained. However, the present invention is also applicable in a modified form to any other projection exposure apparatus having a different exposure wavelength.

In the respective embodiments described above, the projection exposure apparatus, which is provided with both of the exposure function and the measuring function, is explained. However, it is also possible to construct a wavefront aberration measuring device which is provided with any one of the measuring functions of the respective embodiments. In relation to this viewpoint, such a wavefront aberration measuring device is utilized, for example, for assembling and adjusting the projection optical system (see the fifth embodiment).

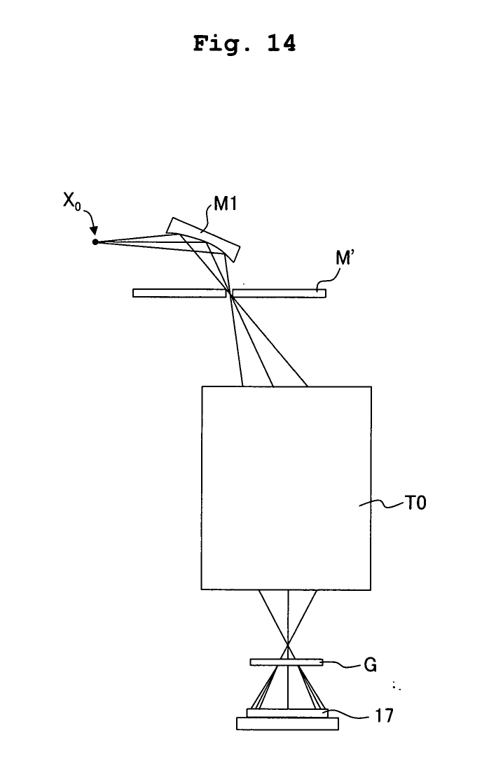

FIG. 14 shows a wavefront aberration measuring device using a light source X₀ having low space coherence, a light-collecting mirror M1, and a transmission type mask M′. An appropriate light source is used for the light source X₀ depending on the wavelength used for the optical system TO to be inspected. For example, when the light beam to be used is the EUV light beam, it is possible to use LPP or DPP. When the wavelength to be used is in the visible region to the ultraviolet region, it is also possible to use a halogen lamp.

In the respective embodiments described above, the mask, in which the dot group is formed, is used. However, it is also allowable to use a diffusion plate in which a diffusion surface is formed in the same pattern as that of the area of formation of the dot group. In this case, it is also allowable to vary the angle of the illumination light, if necessary, in order to suppress the speckle.

In the second embodiment (FIG. 3), the third embodiment (FIG. 5), and the fourth embodiment (FIGS. 7, 9, and 10), the expression (3) is used as the conditional expression for the arrangement pitch Pd. However, it is also allowable to use the following expression (7) in place of the expression (3).

Pd={1/(2M)}×Pg (7)

In this case, the interference fringe caused by the 0-order diffracted light beam and the +1-order diffracted light beam and the interference fringe caused by the 0-order diffracted light beam and the −1-order diffracted light beam are counteracted on the CCD image pickup element 17. The interference fringe, which is caused by the +1-order diffracted light beam and the −1-order diffracted light beam, appears.

In the respective embodiments described above, and explanation is given about the measurement of the wavefront aberration detecting the interference fringe (shearing interference fringe) formed mutually by the light beams including the information about the wavefront aberration. However, the present invention is also applicable to a measurement of the wavefront aberration detecting the interference fringe (point diffraction interference fringe) formed by the light beam including the information about the wavefront aberration and the light beam not including the information about the wavefront aberration. In this case, a mask (dot mask), which converts a part of the diffracted light beam into the ideal spherical wave, may be inserted between the diffraction grating and the CCD image pickup element.

### Fifth Embodiment

A fifth embodiment will be explained. This embodiment relates to a method for manufacturing the projection optical system.

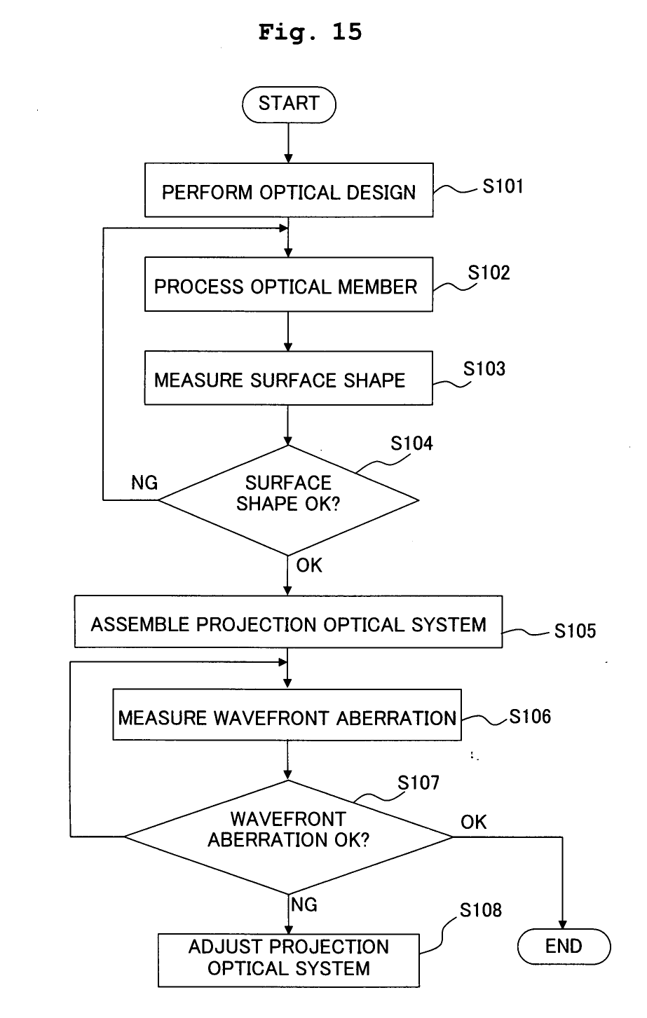

FIG. 15 shows a flow chart illustrating a procedure of the method for manufacturing the projection optical system.

At first, the projection optical system is optically designed (Step S101). In this case, the projection optical system for EUVL as indicated by reference numeral TO in FIG. 1 is designed. In Step S101, surface shapes of the respective optical members (mirrors) included in the projection optical system are determined.

The respective optical members are processed (Step S102). The processing is repeated until the surface accuracy error is small while measuring the surface shape of each of the processed optical members (Steps S102, S103, and S104).

After that, when the surface accuracy errors of all of the optical members are in an allowable range (Step S104 OK), the optical members are completed. The projection optical system is assembled with the optical members (Step S105).

After the assembling, the wavefront aberration of the projection optical system is measured. The wavefront aberration measuring device as described above is applied to the measurement (Step S106). For example, the spacing distance adjustment, the eccentricity adjustment and/or the like are performed for the respective optical members depending on the result of the measurement (Step S108). The projection optical system is completed at the point of time at which the wavefront aberration is within an allowable range (Step S107 OK).

When the wavefront aberration measuring device as described above is utilized in the measurement in Step S106, the wavefront aberration of the projection optical system can be reliably measured. Therefore, it is possible to reliably manufacture the high performance projection optical system.

When the projection optical system is provided on the projection exposure apparatus, a high performance projection exposure apparatus is reliably obtained. Further, a high performance device can be manufactured by using the projection exposure apparatus.

The substrate, which is usable in the embodiments described above, is not limited to the semiconductor wafer for producing the semiconductor device. Applicable substrates include, for example, a glass substrate for the display device, a ceramic wafer for the thin film magnetic head, and a master plate (synthetic silica glass, silicon wafer) for the mask or the reticle to be used for the exposure apparatus.

As for the exposure apparatus, the present invention is also applicable to the scanning type exposure apparatus (scanning stepper) based on the step-and-scan system for performing the scanning exposure with the pattern of the reflection type mask for the exposure by synchronously moving the reflection type mask for the exposure and the substrate as well as the projection exposure apparatus (stepper) based on the step-and-repeat system for performing the full field exposure with the pattern of the reflection type mask for the exposure in a state in which the reflection type mask for the exposure and the substrate are allowed to stand still, while successively step-moving the substrate.

Further, the following procedure is also available. That is, in an exposure based on the step-and-repeat system, a reduction image of a first pattern is transferred onto the substrate by using the projection optical system in a state in which the first pattern and the substrate are allowed to substantially stand still. After that, the full field exposure is performed on the substrate by partially overlaying a reduction image of a second pattern with respect to the first pattern by using the projection optical system in a state in which the second pattern and the substrate are allowed to substantially stand still (full field exposure apparatus based on the stitch system). As for the exposure apparatus based on the stitch system, the present invention is also applicable to the exposure apparatus based on the step-and-stitch system in which at least two patterns are partially overlaid and transferred on the substrate, and the substrate is successively moved.

The present invention is also applicable, for example, to an exposure apparatus in which patterns of two reflection type masks for the exposure are combined (coupled) on the substrate via the projection optical system, and one shot area on the substrate is subjected to the double exposure substantially simultaneously by one time of the scanning exposure, as disclosed, for example, in U.S. Pat. No. 6,611,316.

The present invention is also applicable to a twin-stage type exposure apparatus provided with a plurality of substrate stages as disclosed, for example, in U.S. Pat. Nos. 6,341,007, 6,400,441, 6,549,269, 6,590,634, 6,208,407, and 6,262,796.

Further, the present invention is also applicable to an exposure apparatus including a substrate stage which holds the substrate and a measuring stage which is provided with various photoelectric sensors and/or reference members having reference marks formed therein, as disclosed, for example, in U.S. Pat. No. 6,897,963. The present invention is also applicable to an exposure apparatus provided with a plurality of substrate stages and a plurality of measuring stages.

The type of the exposure apparatus is not limited to the exposure apparatus, for producing the semiconductor element, which exposes the substrate with the semiconductor element pattern. The present invention is also widely applicable, for example, to an exposure apparatus for producing the liquid crystal display device or producing the display as well as to an exposure apparatus for producing, for example, the thin film magnetic head, the image pickup element (CCD), the micromachine, MEMS, the DNA chip, the reticle, or the mask.

As described above, the exposure apparatus according to the embodiment of the present invention is produced by assembling the various subsystems including the respective constitutive elements as defined in claims so that the predetermined mechanical accuracy, electric accuracy and optical accuracy are maintained. In order to secure the various accuracies, those performed before and after the assembling include the adjustment for achieving the optical accuracy for the various optical systems, the adjustment for achieving the mechanical accuracy for the various mechanical systems, and the adjustment for achieving the electric accuracy for the various electric systems. The steps of assembling the various subsystems into the exposure apparatus include, for example, the mechanical connection, the wiring connection of the electric circuits, and the piping connection of the air pressure circuits in correlation with the various subsystems. It goes without saying that the steps of assembling the respective individual subsystems are performed before performing the steps of assembling the various subsystems into the exposure apparatus. When the steps of assembling the various subsystems into the exposure apparatus are completed, the overall adjustment is performed to secure the various accuracies as the entire exposure apparatus. It is desirable that the exposure apparatus is produced in a clean room in which the temperature, the cleanness and the like are managed.

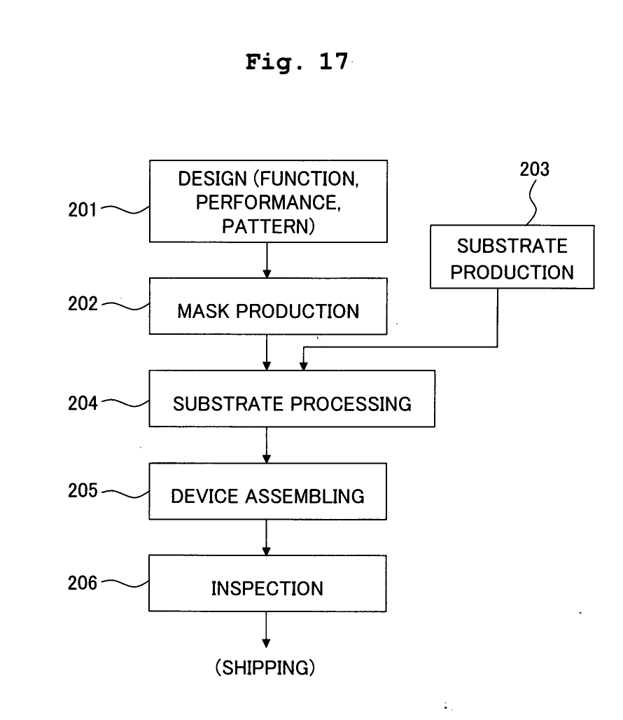

As shown in FIG. 17, the microdevice such as the semiconductor device is produced by performing, for example, a step 201 of designing the function and the performance of the microdevice, a step 202 of manufacturing a reflection type mask for the exposure (reticle) based on the designing step, a step 203 of producing a substrate as a base material for the device, a substrate-processing step 204 including the substrate processing (exposure process) of exposing the substrate with the image of the pattern of the reflection type mask for the exposure in accordance with the embodiment described above and developing the exposed substrate, a step of assembling the device (including a dicing step, a bonding step, and a packaging step) 205, and an inspection step 206.

The disclosures of all of the published patent documents and United States patents, which relate to, for example, the exposure apparatus and which are referred to in the respective embodiments and the modified embodiments described above, are incorporated herein by reference within a range of permission of the laws and ordinances.

The embodiments of the present invention have been explained above. However, in the present invention, it is possible to appropriately combine and use all of the constitutive elements described above. Further, in the present invention, a part or parts of the constitutive elements are not used in some cases.

### Example 1

An example of the mask is shown below.

Measuring wavelength λ=13.5 nm;

Numerical aperture NA′ of the illumination optical system=0.0625;

Numerical aperture NA of the projection optical system=0.25;

Magnification M of the projection optical system=¼;

Illumination sigma value σ=0.8;

Width of the area E=400 μm;

Grating pitch Pg of the diffraction grating=1 μm;

Shear ratio=(λ/Pg)/(2NA)= 1/37;

Dot diameter σ=100 nm;

Arrangement pitch Pd of the dot groups=4 μm;

Center spacing distance L between the adjacent dots in the shear direction in the dot group=164 nm;

Center spacing distance L between the adjacent dots in the non-shear direction in the dot group=120 nm.

In particular, the dot diameter σ satisfies the expression of σ<λ/(2NA)/M. Therefore, the individual dot can generate the ideal spherical wave.

The center spacing distance L between the adjacent dots in the shear direction in the dot group=164 nm is the shortest distance=0.61×λ/(σNA′) at which the coherence degree on the mask is zero. The center spacing distance L between the adjacent dots in the non-shear direction in the dot group=120 nm is the value approximate to the dot diameter σ=100 nm.

The arrangement pitch Pd of the dot groups and the grating pitch Pg of the diffraction grating satisfy the expression (3). Therefore, it is possible to maintain the high contrast of the interference fringe.

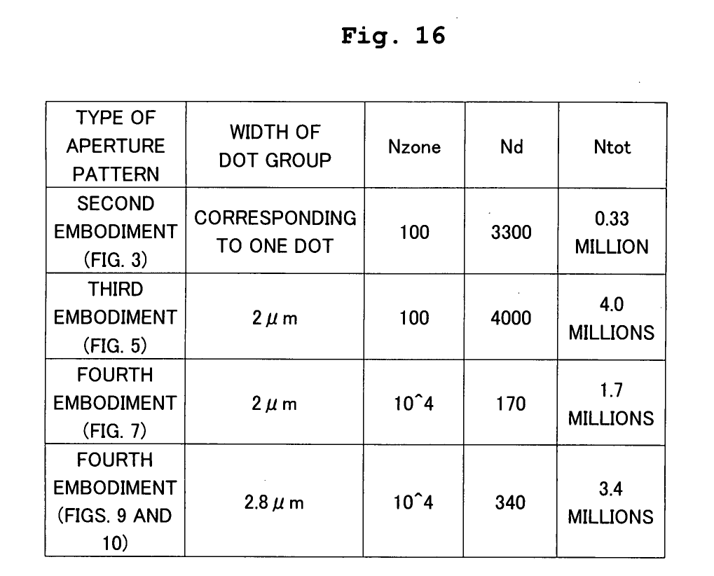

The total numbers of dots, which are obtained when Example 1 is adapted to the second embodiment (FIG. 3), the, third embodiment (FIG. 5), the fourth embodiment (FIG. 7), and the fourth embodiment (FIG. 9), are as shown in FIG. 16.

In FIG. 16, the following assumption is affirmed.

N_{ZONE}=number of the dot groups;

Nd=number of the dots in the dot group;

Nₜₒₜ=total number of the dots=N_{ZONE}×Nd.

On this assumption, in FIGS. 3 and 5, N_{ZONE}=width of the area E/Pd is given. In FIGS. 7 and 9, N_{ZONE}=(width of the area E/Pd)² is given. As appreciated from FIG. 16, the light amount can be increased as much as 330,000 times to 3,400,000 times as compared with a case in which the single aperture is used.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

What is claimed is:

1. A wavefront aberration measuring device comprising:
a mask which arranges a group of minute apertures for generating a group of point light sources at an object point as a measurement objective of an inspection-objective optical system;
an illumination system which illuminates the mask with an illumination light;
a diffraction grating which shears, into a plurality of light fluxes, a light flux exiting from the group of minute apertures and passing via the inspection-objective optical system; and
a detecting portion which detects an interference fringe formed mutually by the plurality of sheared light fluxes, wherein the following expression holds:
(Pg²/λ)×(N−0.2)≦Lg≦(Pg²/λ)×(N+0.2)
wherein Lg represents a displacement amount from a back side focal plane of the inspection-objective optical system to the diffraction grating, Pg represents a grating pitch of the diffraction grating, λ represents a wavelength of the illumination light, and N represents an arbitrary natural number.

2. The wavefront aberration measuring device according to claim 1, wherein the group of minute apertures is provided as a plurality of groups of minute apertures arranged by the mask periodically at the object point as the measurement objective.

3. The wavefront aberration measuring device according to claim 2, wherein an arrangement pitch Pd in a shear direction of the plurality of groups of minute apertures, the grating pitch Pg of the diffraction grating, and a magnification M of the inspection-objective optical system satisfy the following expression:
Pd=(1/M)×Pg.

4. The wavefront aberration measuring device according to claim 2, wherein an arrangement pitch Pd in a shear direction of the plurality of groups of minute apertures, the grating pitch Pg of the diffraction grating, a magnification M of the inspection-objective optical system, the displacement amount Lg from the back side focal plane to the diffraction grating, and a displacement amount Lc from the back side focal plane to the detecting portion satisfy the following expression:
Pd=(1/M)×{Pg/(1−Lg/Lc)}.

5. The wavefront aberration measuring device according to claim 2, wherein an arrangement pitch Pd in a shear direction of the plurality of groups of minute apertures and a width W in the shear direction of each of the groups of minute apertures satisfy the following expression:
W/Pd<0.8.

6. The wavefront aberration measuring device according to claim 1, wherein the following expression holds:
L={X₀/(2π)}×{λ/(σ×NA′)}
wherein L represents a center spacing distance between adjacent minute apertures which are adjacent in a shear direction in the group of minute apertures, NA′ represents a numerical aperture of the illumination system, σ represents an illumination sigma value of the mask, λ represents the wavelength of the illumination light, and X₀ represents a zero point of a linear Bessel function of the first kind.

7. The wavefront aberration measuring device according to claim 1, wherein the wavelength λ of the illumination light satisfies the following expression:
11 nm<λ<14 nm.

8. The wavefront aberration measuring device according to claim 7, wherein a light source of the illumination system is a laser plasma light source or a discharge plasma light source.

9. A projection exposure apparatus comprising:
a projection optical system which transfers a pattern of an exposure mask to an exposure objective;
an exposure illumination system which illuminates the exposure mask; and
the wavefront aberration measuring device, as defined in claim 1, which measures a wavefront aberration of the projection optical system.

10. The projection exposure apparatus according to claim 9, wherein at least a part of the exposure illumination system is used for the illumination system of the wavefront aberration measuring device.

11. A method for manufacturing a projection optical system, comprising:
a step of measuring a wavefront aberration of the projection optical system by using the wavefront aberration measuring device as defined in claim 1; and
a step of adjusting the projection optical system depending on a result of the measurement.

12. A method for manufacturing a device, comprising:
exposing a substrate by using the projection exposure apparatus as defined in claim 9; and
developing the exposed substrate.

13. A wavefront aberration measuring device comprising:
a mask which arranges a group of minute apertures for generating a group of point light sources at an object point as a measurement objective of an inspection-objective optical system;
an illumination system which illuminates the mask with an illumination light;
a diffraction grating which shears, into a plurality of light fluxes, a light flux exiting from the group of minute apertures and passing via the inspection-objective optical system; and
a detecting portion which detects an interference fringe formed mutually by the plurality of sheared light fluxes;
wherein a center spacing distance L between adjacent minute apertures which are adjacent in a shear direction in the group of minute apertures is defined to minimize a coherence degree.

14. The wavefront aberration measuring device according to claim 13, wherein the coherence degree is zero.

15. The wavefront aberration measuring device according to claim 13, wherein the following expression holds:
L={X₀/(2π)}×{λ/σ×NA′)}
wherein L represents the center spacing distance, NA′ represents a numerical aperture of the illumination system, a represents an illumination sigma value of the mask, λ represents a wavelength of the illumination light, and X₀ represents a zero point of a linear Bessel function of the first kind.

16. A projection exposure apparatus comprising:
a projection optical system which transfers a pattern of an exposure mask to an exposure objective;
an exposure illumination system which illuminates the exposure mask; and
the wavefront aberration measuring device, as defined in claim 13, which measures a wavefront aberration of the projection optical system.

17. The projection exposure apparatus according to claim 16, wherein at least a part of the exposure illumination system is used for the illumination system of the wavefront aberration measuring device.

18. A method for manufacturing a projection optical system, comprising:
a step of measuring a wavefront aberration of the projection optical system by using the wavefront aberration measuring device as defined in claim 13; and
a step of adjusting the projection optical system depending on a result of the measurement.

19. A method for manufacturing a device, comprising:
exposing a substrate by using the projection exposure apparatus as defined in claim 16; and
developing the exposed substrate.
